(19) United States
(12) Patent Application Publication
(10) Pub. No.: US 2006/0170351 A1
(43) Pub. Date: Aug. 3, 2006

(54) Plasma display panel

(76) Inventor: Eun-Young Jung, Suwon-si (KR)

Correspondence Address: LEE & MORSE, P.C., 1101 WILSON BOULEVARD, SUITE 2000, ARLINGTON, VA, 22209, US

(21) Appl. No.: 11/332,239

(22) Filed: Jan. 17, 2006

(30) Foreign Application Priority Data
Feb. 2, 2005 (KR) 10-2005-0009725

(51) Int. Cl. H01J 17/49

(52) U.S. Cl. 313/582

(57) ABSTRACT

An electrode structure of a plasma display panel (PDP) may include a plurality of electrode pairs and a floating electrode pair arranged between at least one of the plurality of electrode pairs associated with a discharge cell of the PDP. The electrode structure enables an electric potential between the X-electrode and the Y-electrode associated with one of the discharge cells to be increased such that a distance between the X-electrode and the Y-electrode may be increased, which increases an amount of discharge of the respective discharge cell.

### BACKGROUND OF THE INVENTION

1. Field of the Invention

The present invention relates to a plasma display panel (PDP), and more particularly, to an electrode structure of a PDP for realizing improved brightness by increasing an amount of discharge in discharge cells of the PDP.

2. Description of the Related Art

PDPs are display devices that display images using gas discharge phenomena. In particular, PDPs display images by exiting phosphors using ultraviolet light created by gas discharge. PDPs are relatively slim display devices capable of realizing a high-resolution and large-sized screen.

PDPs may be classified as AC type PDPs, DC type PDPs, and hybrid type PDPs according to a structure and operation principle of the PDP. The AC type PDPs and the DC type PDPs may be further classified as surface-discharge type PDPs and opposed-discharge type PDPs according to their discharge structure.

Lower cost PDPs are desired as PDPs rapidly develop, the PDPs of low costs, high image quality, and improved brightness are required so as to meet competitiveness in the market.

However, since the PDPs realize an image using discharge occurring in each of discharge cells, a discharge amount occurring in each of the discharge cells should be increased so as to enhance brightness of the PDPs.

However, such an increase of the discharge amount should not be associated with an increase of manufacturing costs, which makes development of the PDPs difficult.

### SUMMARY OF THE INVENTION

The present invention is therefore directed to a PDP, which substantially overcomes one or more of the problems due to the limitations and disadvantages of the related art.

It is therefore a feature of the present invention to provide a PDP capable of improving brightness by increasing a discharge amount.

It is therefore another feature of the present invention to provide a PDP capable of lowering a firing voltage.

It is therefore yet another feature of the present invention to provide a PDP that can be manufactured through a simple process and at low cost.

At least one of the above and other features and advantages of the present invention may be realized by providing a plasma display panel (PDP) including a front substrate, a rear substrate facing the front substrate, and a plurality of discharge cells defined between the front substrate and the rear substrate. The PDP may further include a plurality of electrode pairs, each electrode pair may include an X-electrode and an Y-electrode associated with each of the plurality of discharge cells and the X-electrodes and the Y-electrodes may be supported on the front substrate, and floating electrode pairs, which may each be formed between the X-electrode and the Y-electrode associated with one of the discharge cells. Each floating electrode pair may have an X-floating electrode disposed more closely to the X-electrode than to the Y-electrode and a Y-floating electrode disposed more closely to the Y-electrode than to the X-electrode. The PDP may further include phosphor layers respectively disposed within the discharge cells and discharge gas inside the discharge cells.

The X-electrodes and the Y-electrodes may be made of a metal conductor. The X-electrodes and the Y-electrodes may each include a bus electrode made of a conductive material and a transparent electrode. The X-floating electrode and the Y-floating electrode of the floating electrode pair may be made of a metal conductor. The X-floating electrode and the Y-floating electrode of the floating electrode pair may be made of a transparent electrode. The X-floating electrode and the Y-floating electrode may be disposed to extend along one direction and to be parallel to each other. The X-floating electrode for each of the discharge cells may be disposed to be electrically insulated from X-floating electrodes of other ones of the discharge cells. The Y-floating electrode for each of the discharge cells may be disposed to be electrically insulated from Y-floating electrodes of other ones of the discharge cells. Each of the X-electrodes and the Y-electrodes may be disposed to extend along one direction and to be parallel to each other. The PDP may further include a front dielectric layer supported and disposed on the front substrate to cover the electrode pairs. The PDP may further include a rear dielectric layer supported and disposed on the rear substrate to cover the address electrodes.

At least one of the above and other features and advantages of the present invention may be separately realized by providing a plasma display panel (PDP) including a first substrate, a second substrate overlapping the first substrate and a plurality of discharge cells defined between the first substrate and the second substrate. The PDP may further include a plurality of electrode pairs arranged on the first substrate, each electrode pair may include an X-electrode and an Y-electrode and each of the discharge cells may be associated with at least a portion of one of the X-electrodes and one of the Y-electrodes. The PDP may further include potential increasing members for increasing an electric potential difference between the X-electrode and the Y-electrode of one of the electrode pairs associated with one of the discharge cells. The PDP may further include phosphor layers respectively disposed within the discharge cells and discharge gas inside the discharge cells.

The potential increasing member may include a pair of electrodes arranged between the X-electrode and the Y-electrode of the electrode pair. The potential increasing member may be made of a conductive material. The X-electrode and the Y-electrode of each of the electrode pairs may be formed of a conductive material. The X-electrode and the Y-electrode of each of the electrode pairs may be formed of a non-transparent conductive material. The potential increasing member associated with each of the discharge cells may be electrically insulated from each other. The potential increasing member associated with each of the discharge cells may function independently of any electrical signals applied thereto.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a PDP according to an embodiment of the invention;

FIG. 2 illustrates a sectional view of the PDP shown in FIG. 1, along line II-II of FIG. 1;

FIG. 3 illustrates an exploded perspective view of a PDP according to another embodiment of the invention;

FIG. 4 illustrates a sectional view of the PDP shown in FIG. 3, along line IV-IV of FIG. 3; and

FIG. 5 illustrates an exploded perspective view of a PDP according to another embodiment of the invention.

### DETAILED DESCRIPTION OF THE INVENTION

Korean Patent Application No. 10-2005-0009725, filed on Feb. 2, 2005, in the Korean Intellectual Property Office, and entitled, “Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

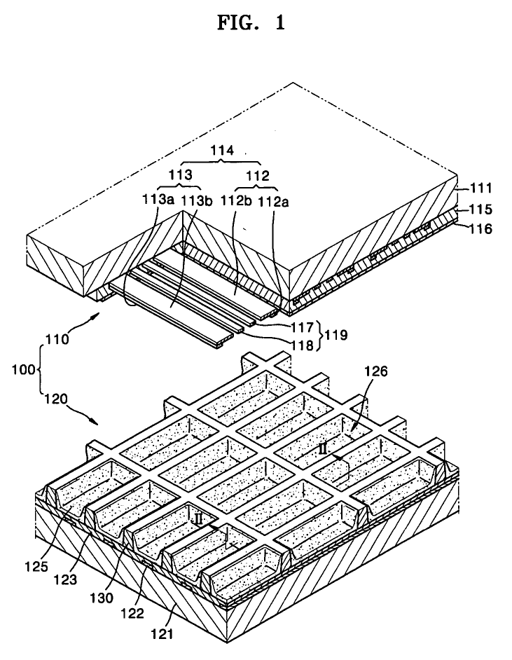

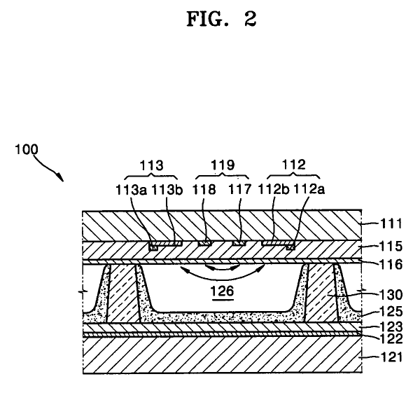

FIG. 1 illustrates an exploded perspective view of a PDP according to an embodiment of the present invention. FIG. 2 illustrates a sectional view of the PDP shown in FIG. 1, along line II-II of FIG. 1. As shown in FIGS. 1 and 2, PDP 100 may have a front plate 110 and a rear plate 120. The front plate 110 may have a front substrate 111, electrode pairs 114, floating electrode pairs 119, and a front dielectric layer 115. Each of the electrode pairs 114 may have an X-electrode 113 and a Y-electrode 112 supported and disposed on the front substrate 111 for each discharge cell. Each of the floating pairs 119 may be disposed between the X-electrode 113 and the Y-electrode 112, and may have an X-floating electrode 118 and a Y-floating electrode 117. The X-floating electrode 118 may be disposed more closely to the X-electrode 113 than to the Y-electrode 112. The Y-floating electrode 117 may be disposed more closely to the Y-electrode 112 than to the X-electrode 113. The X-electrode 113 and the Y-electrode 112 may be buried in or covered by the front dielectric layer 115. For example, the X-electrode 113 and the Y-electrode may be sandwiched between the front substrate and the front dielectric layer 115. The front dielectric layer 115 may be covered with a protective layer 116.

The rear plate 120 may have a rear substrate 121, address electrodes 122 and a rear dielectric layer 123. The rear substrate 121 may be disposed facing the front substrate 111. The address electrodes 122 may be supported on the rear substrate 121 and may be arranged so as to extend along a direction that crosses a direction along which the electrode pairs 114 extend. Overlapping portions of the address electrodes 122 and the electrode pairs 114 may define discharge cells 126, which will be described in more detail below. The address electrodes 122 may be buried in or covered by the rear dielectric layer 123.

Barrier ribs 130 may be disposed between the front substrate 111 and the rear substrate 121. The barrier ribs 130, the front substrate 111 and the rear substrate 121 may together partition respective ones of the discharge cells 126. Phosphor layers 125 may be arranged inside each of the discharge cells 126. Discharge gas may exist inside each of the discharge cells 126.

Edges of the front plate 110 and the rear plate 120 may be sealed or bonded together. For example, edges of the front plate 110 and the rear plate 120 may be bonded together using an adhesive, such as frit.

The front substrate 111 may be formed of a transparent material having a predetermined strength, e.g., soda glass or transparent plastics.

As discussed above, the electrode pairs 114 may be supported and disposed on the front substrate 111 and thus, they may be positioned along an optical path through which visible light propagates. Therefore, each of the X-electrodes 113 and the Y-electrodes 112 may include transparent electrodes 113b and 112b formed of transparent material, e.g., indium tin oxide (ITO), and bus electrodes 113a and 112a formed of a metal conductor, e.g., Ag, Cu, and Cr. in consideration of visible light transmission. The X-electrodes 113 and the Y-electrodes 112 may extend parallel to each other.

The floating electrode pairs 119 may be formed of a metal conductor. As discussed above, the floating electrode pairs 119 may be disposed along an optical path through which visible light propagates. Thus, the floating electrode pairs 119 may be formed of a transparent material, e.g., ITO, in consideration of visible light transmittance. Functions of the floating electrodes 119 will be described in detail below.

The electrode pairs 114 and the floating electrode pairs 119 may be formed by spreading electrode paste on a surface of the front substrate 111. The electrode paste may include one or more of the materials mentioned above. The electrode paste may be spread over the entire surface of the front substrate and may be formed using screen printing. The electrode paste may be dried and patterned by processes such as plastic-working to form the electrode pairs 114 and/or the floating electrode pairs 119. In embodiments of the invention, the electrode pairs 114 and the floating electrode pairs 119 may be formed by using photolithography, which generally involves adding a photosensitive photoresist to the electrode paste and etching the electrode paste using photosensitive equipment.

The front dielectric layer 115 may induce wall charges for discharge of the gas inside the discharge cells 126 by inducing charged particles using an electric potential applied to the electrode pairs 114. The front dielectric layer may also protect sustain electrodes, i.e., the electrode pairs 114.

The front dielectric layer 115 may be formed by spreading dielectric paste using screen printing and patterning the dielectric paste by a burning process. The dielectric paste may be formed of PbO, SiO₂.

The protective layer 116 may be formed of MgO and may help discharge of the gas by increasing emission of a secondary electron during discharge. The protective layer 116 may also protect the front dielectric layer 115 and the electrode pairs 114 from collisions by accelerated charged particles during discharge and may thereby help extend a life of the PDP 100. The protective layer 116 may be formed by deposition.

The rear substrate 121 and the front substrate 111 may be formed of soda glass. In embodiments where the rear substrate 121 is not disposed along an optical path through which the visible light created inside the discharge cells 126 propagates, the rear substrate 121 may be formed of a non-transparent material, e.g., plastics and metal.

As discussed above, the address electrodes 122 may be supported and disposed on the rear substrate 121 and may not be positioned along an optical path through which visible light propagates. Thus, the address electrodes 122 may not necessarily be formed of transparent material, e.g., ITO, and may be formed of a non-transparent and/or highly electrically conductive material, e.g., Ag, Cu, and Cr.

In embodiments of the invention, the rear dielectric layer 123 covering the address electrodes 122 may not be provided. In embodiments of the invention, the rear dielectric layer 123 may not be provided because the phosphor layers 125 may cover the address electrodes 122 and may serve as dielectric layers.

In embodiments of the invention, the rear dielectric layer 123 may be arranged to cover the address electrodes 122 to reduce and/or prevent damage to the address electrodes 122 and to help address discharge to occur more easily. In embodiments of the invention where sandblasting is utilized for forming the barrier ribs 130, the rear dielectric layer 123 may help reduce and/or prevent damage to the address electrodes that may result from the barrier rib forming process.

The barrier ribs 130 may be formed of a glass material. The glass material may contain elements such as Pb, B, Si, Al, and O. In embodiments of the invention, the barrier ribs 130 may include a filler such as ZrO₂, TiO₂, and Al₂O₃ and a pigment such as Cr, Cu, Co, Fe, and TiO₂.

The barrier ribs 130 may be formed by spreading barrier rib material paste and patterning the barrier rib material paste using processes such as sandblasting, photolithography and etching.

As shown in FIG. 1, the discharge cells 126 may have a generally rectangular shape. The shape of the discharge cells 126 is not, however, limited to such a generally rectangular shape. In embodiments of the invention, the discharge cells 126 may have various shapes such as polygonal, circular and/or honeycomb shapes.

A horizontal cross-section of the discharge cells 126 may not have a closed shape and may have an opening or gap along boundaries of the discharge cells 126. In embodiments of the invention where the cross-section of the discharge cells 126 has a closed shape, as shown in FIG. 2, the electrode pairs 114 may be arranged along the barrier ribs 130 such that the electrode pairs 114 surround the discharge cells 126 at least partially defined by the barrier ribs 130. Such discharge cells 126 having a horizontal cross-section with a closed shape enable 3-dimensional discharge and may help increase a discharge amount.

The phosphor layers 125 may include red, green, and blue phosphor layers that allow the PDP 100 to display a color image. The red, green and blue phosphor layers may be disposed and combined inside each of the discharge cells 126 to form a unit pixel for realizing a color image.

The phosphor layers 125 may be formed by disposing phosphor paste in a space between the barrier ribs 130 and the rear substrate 121. The phosphor paste may be a mixture of red, green and blue phosphors, a solvent and a binder. After the phosphor paste is disposed, the phosphor paste may be dried and patterned by a process such as plastic-working.

The red phosphor may be (Y,Gd)BO₃:Eu³⁺. The green phosphor may be Zn₂SiO₄:Mn²⁺. The blue phosphor may be BaMgAl₁₀O₁₇:Eu²⁺.

As discussed above, one of a plurality of different colored, e.g., red, blue and green, phosphor layers 125 may be provided in each of the discharge cells 126. A unit pixel, i.e., a basic unit for realizing an image, may be formed of a plurality of adjacent ones of the discharge cells 126 such that each unit pixel includes discharge cells associated with each of the different colors of phosphor layers 125. For example, the unit pixel may include three adjacent ones of the discharge cells 126 and one of the discharge cells 125 of the unit pixel may include green colored phosphor layer 125, another of the discharge cells 126 of the unit pixel may include blue colored phosphor layer 125 and another of the discharge cells 126 of the unit pixel may include red colored phosphor layer 125. In embodiments of the invention, respective ones of the discharge cells 126 associated with a single unit pixel may be arranged differently. For example, respective ones of the discharge cells 126 associated with a single pixel may be arranged adjacent to each other along a single direction, i.e., forming a line, or may be arranged about each other, i.e., forming a triangle, square, rectangle, polygon, etc. In embodiments of the invention, the arrangement of the discharge cells may be in the form of a grating type or a delta type. Depending on the efficiency of the phosphor material used for each color, a size and/or a shape of the discharge cells 126 corresponding to each color of phosphor material may be varied. For example, respective discharge cells 126 associated with each color of phosphor material may have different widths and/or lengths depending on the efficiency of each of the different colored phosphor materials.

The arrangement of the phosphor layers 125 may not be necessarily disposed in a space confined by the rear substrate 121 and the barrier ribs 130 as illustrated in FIG. 1. In embodiments of the invention, the phosphor layers 125 may be disposed in a space confined by the barrier ribs 130 and the front substrate 111 or another space.

The discharge gas existing within the discharge cells 126 may be one gas or a mixture of gases. In embodiments of the invention, the discharge gas may be a mixture of two or more gases selected from a group consisting of Xe, Ne, He, Ar and any mixtures and combinations thereof. The discharge gas may fill the discharge cells 126 with a pressure lower than atmospheric pressure and thus, a compressing force using vacuum pressure may be applied to the front plate 110 and the rear plate 120. The barrier ribs 130 may support and help maintain a gap between the front plate 110 and the rear plate 120.

The operation of the PDP 100 and functions of the floating electrode pairs 119 will be described below.

The PDP 100 according to the present embodiment may be driven by various driving methods such as an address-display period separation (ADS) method, an alternate lighting of surfaces (ALIS) method and an addressing while display (AWD) method. Though many factors, e.g. an image quality, a response speed, of the PDP may change depending on the driving method employed, any known driving method may be employed with one or more aspects of the. The exemplary PDP 100 described below employs the ADS method.

To display an image, different discharges may occur within each of the discharge cells 126 of the PDP 100. A state of wall charges or an amount of charged particles may differ for the respective discharge cells 126. Such differences may make it difficult to uniformly control the discharges that occur within each of the discharge cells 126

In embodiments of the invention, to help suitably control the different discharges in the discharge cells 126, a high-voltage may be applied to all of the discharge cells 126 to simultaneously trigger a gas discharge in all of the discharge cells 126. The applied high-voltage may be a voltage greater than a predetermined voltage level. Such a simultaneous discharge of the discharge cells may remove substantially all or all of the wall charges existing inside each of the discharge cells 126 thereby, placing the discharge cells 126 in a uniformly charged state, i.e., same state. Such a discharge is called reset discharge.

The reset discharge may be performed by applying a ramp potential, e.g., a high potential, on all of the Y-electrodes 112, applying a ground potential on all of the address electrodes 122 and applying a bias potential on the X-electrodes 113 for a predetermined period of time to thereby discharge all of the discharge cells 126.

After the above-described reset discharge occurs, address discharge may occur. Address discharge corresponds to discharge associated with selecting or addressing discharge cells 126 based on an external image signal identifying the discharge cells that are to undergo a discharge for realizing an image. As discussed above, the discharge cells 126 may be disposed at overlapping portions between the electrodes, e.g., the Y-electrodes 112, of the electrode pairs 114 and the address electrodes 122. During an address discharge, predetermined pulse voltages having opposite polarities may be applied to respective ones or portions of the Y-electrodes 112 and the address electrodes 122 to create discharge in the selected ones of the discharge cells 126. As a result of the applied pulses, charged particles may stick on the front dielectric layer 115 within selected ones of the discharge cells 126 to allow wall charges to be accumulated on respective portions of the front dielectric layer 115.

After an address discharge occurs, when a pulse of a high potential is applied to the Y-electrodes 112 and a pulse of a relatively low potential is applied to the X-electrodes 113, the wall charges accumulated on a surface of the discharge cells 126, e.g., respective surface of the front dielectric layer, during the address discharge move due to a potential difference generated between the X-electrodes 113 and the Y-electrodes 112. Atoms of the discharge gas in the inside the discharge cells 126 may collide with the moving wall charges generating discharge and creating plasma.

Ultraviolet light may be created when the discharge excites the phosphor layers 125 disposed within the respective discharge cells 126 and visible light may be created while the respective excited phosphor layers 125 move to a lower energy level, thereby realizing an image on the PDP.

Discharge of the gas within the discharge cells 126 stops when a potential difference between the electrodes pairs 114 is reduced to a value lower than a discharge voltage after the discharge occurs and space charges and wall charges may form in the discharge cells 126. When a pulse voltage is alternately applied between respective electrodes of the electrode pairs 114, a firing voltage may again be created with the help of the wall charges, thereby enabling another discharge.

Such discharge is called sustain discharge, by which a gray scale of the PDP 100 may be determined and an image may be realized.

When the sustain discharge occurs, an electric field range influencing the charged particles inside the discharge cells 126 may increase as a distance between the X-electrode 113 and the Y-electrode 112 increases. However, when the distance between the X-electrode 113 and the Y-electrode 112 increases and an electric potential applied between the X-electrode 113 and the Y-electrode 112 is constant, the intensity of the electric field formed inside the discharge cells 126 decreases. The reduction in the intensity of the electric field formed inside the discharge cells 126 corresponds to the charged particles, within the discharge cells 126, which cannot be properly accelerated to have a sufficient kinetic energy. As a result, a discharge may not occur.

Therefore, to increase the intensity of the electric field between the X-electrode 113 and the Y-electrode 112 when the distance between the X-electrode 113 and the Y-electrode 112 increases, the electrical potential applied between the X-electrode 113 and the Y-electrode 112 should be increased. A price of an integrated circuit (IC) chip employable for controlling an electric signal applied to the X-electrode 113 and the Y-electrode 112 may increase manufacturing costs of the PDP and may lower competitive pricing ability.

The exemplary PDP 100 shown in FIGS. 1 and 2 overcomes such problems by disposing the floating electrode pairs 119 between the X-electrodes 113 and the Y-electrodes 112. When an electric potential is applied to the X-electrode 113, an electric potential having an intensity similar to that of the electric potential applied to the X-electrode 113 may be induced at the X-floating electrode 118 disposed closely to the X-electrode 113. When an electric potential is applied to the Y-electrode 112, an electric potential having an intensity similar to that of the electric potential applied to the Y-electrode 112 may be induced at the Y-floating electrode 117 disposed closely to the Y-electrode 112. That is, a potential difference similar to the potential difference between the X-electrode 113 and the Y-electrode 112 may be formed between the X-floating electrode 118 and the Y-floating electrode 117. Initial discharge may occur inside of the discharge cells 126 due to this potential difference between the X-floating electrode 118 and the Y-floating electrode 117.

Discharge between the X-electrode 113 and the Y-electrode 112 may be caused by the initial discharge occurring between the X-floating electrode 118 and the Y-floating electrode 117 such that discharge extends between the X-electrode 113 and the Y-electrode 112 before the X-electrode 113 and the Y-electrode 112 generate discharge. As discussed above, the distance between the X-electrode 113 and the Y-electrode 112 is greater than a distance between the X-floating electrode 118 and the Y-floating electrode 117, and resultantly a discharge amount increases.

In embodiments of the invention, it is therefore possible to increase a discharge amount by increasing the distance between the X-electrode 113 and the Y-electrode 112 with the help of the floating electrode pair 119 without increasing in the driving voltage which drives the electrode pair 114.

In embodiments of the invention, even though the distance between the X-electrode 113 and the Y-electrode 112 may be increased, a potential difference existing between the X-electrode 113 and the Y-electrode 112 may be increased by inducing a potential difference between the X-floating electrode 118 and the Y-floating electrode 117 disposed between the X-electrode 113 and the Y-electrode 112, so as to generate an initial discharge. In such embodiments, even though the distance between the X-electrode 113 and the Y-electrode 112 may be increased, the driving voltage for driving the X-electrode 113 and the Y-electrode 112 need not be increased. In embodiments of the invention, a predetermined voltage may be applied between the X-floating electrode 118 and the Y-floating electrode 117 by an external driving unit. In embodiments of the invention, a predetermined voltage may not be applied by an external driving unit and the electric potential may be naturally induced using potential induction.

Embodiments of the invention therefore make it possible to increase a discharge amount without raising the price of the IC chip, as described above. Embodiments of the invention separately provide for improved brightness of the PDP 100 as a result of the increase in the discharge amount, which is directly associated with an increase of ultraviolet generation.

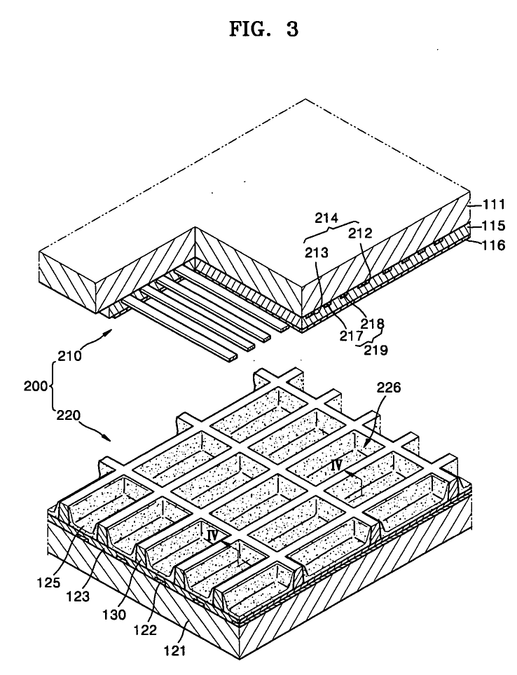

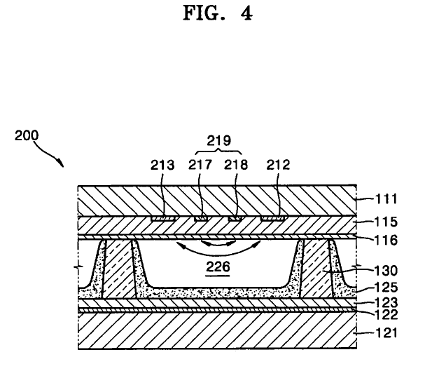

A PDP 200 according to another exemplary embodiment of the present invention will be described with reference to FIGS. 3 and 4.

The difference between the PDP 200 according to the present embodiment and the PDP 100 shown in FIG. 1 is that an X-electrode 213 and a Y-electrode 212 may be formed only of a metal conductor only and without a transparent electrode.

As discussed above, the X-electrodes 113 and the Y-electrodes 112 of the PDP 100 may be disposed along an optical path through which visible light propagates and thus, the metal bus electrodes 113a and 112a may be disposed near the locations of the barrier ribs 130 so that the visible light from inside the discharge cells 126 may not be blocked off and the transparent electrodes 113b and 112b may be disposed along the optical path through which the visible light propagates and may transmit the visible light.

However, the transparent electrode, which may be formed of ITO, generally requires high manufacturing costs compared with the metal bus electrode and are generally hard to form. Thus, employing such transparent electrodes may increase manufacturing costs of the PDP. However, when the transparent electrodes are not used, the distance between the X-electrodes and the Y-electrodes may excessively increase and thus, the required driving voltage may increase, thereby increasing manufacturing costs of the PDP even more as a result of a more expensive IC chip that is capable of providing the increased driving voltage.

In embodiments of the invention, the PDP 200 may include floating electrode pairs 219 disposed between the X-electrodes 213 and the Y-electrodes 212, i.e., an electrode pair 214, so that the driving voltage need not increase. That is, in embodiments of the invention, with the help of the floating electrode pairs 219 even though the X-electrodes 213 and the Y-electrodes 212 may be formed only of a metal conductor and may have a greater distance between them, the driving voltage need not be increased and the manufacturing costs of the PDP 200 may be reduced.

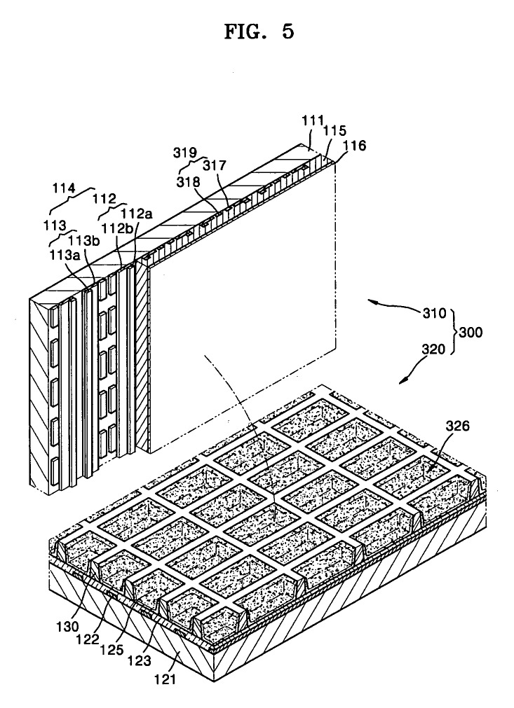

The differences between a PDP 300 according to another exemplary embodiment and the PDP 100 shown in FIG. 1 will be described below with reference to FIG. 5.

As discussed above, floating electrode pairs 319 incluidng X-floating electrodes 318 and Y-floating electrodes 317 may not be electrically connected to the outside and they may not necessarily extend along one direction. In embodiments of the invention, as shown in FIG. 5, each of the X-floating electrodes 318 and/or the Y-floating electrodes 317 may be electrically separated for each discharge cell 326.

In embodiments of the invention, where each of the X-floating electrodes 318 or the Y-floating electrodes 317 is electrically separated for each discharge cell 326, even though discharge may be induced by adjacent X-electrodes 113 and the Y-electrodes 112, respective X-floating and Y-floating electrodes 318, 317 may be electrically isolated within the discharge cells 326 so that other discharge cells may not be influenced by the discharge of another discharge cell and thus, a discharge error can be prevented.

In embodiments of the invention having the above described structure, the distance between the electrodes of the PDP may be increased thereby increasing a discharge amount of each of the discharge cells and improving brightness.

In embodiments of the invention, the firing voltage may be lowered and the manufacturing costs of elements such as the IC chip for driving the PDP may be reduced, so that the manufacturing costs of the PDP may be reduced.

One or more aspects of the invention provide PDPs that do not employ transparent electrodes and thus, such embodiments of the invention enable costs required for forming such transparent electrodes to be saved. In such embodiments, manufacturing process of the PDP may be simplified and manufacturing costs of the PDP may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a front substrate;
a rear substrate facing the front substrate;
a plurality of discharge cells defined between the front substrate and the rear substrate;
a plurality of electrode pairs, each electrode pair including an X-electrode and an Y-electrode associated with each of the plurality of discharge cells and the X-electrodes and the Y-electrodes being supported on the front substrate;
floating electrode pairs each formed between the X-electrode and the Y-electrode associated with one of the discharge cells, each floating electrode pair having an X-floating electrode disposed more closely to the X-electrode than to the Y-electrode and a Y-floating electrode disposed more closely to the Y-electrode than to the X-electrode;
phosphor layers respectively disposed within the discharge cells; and
discharge gas inside the discharge cells.

2. The PDP as claimed in claim 1, wherein the X-electrodes and the Y-electrodes are made of a metal conductor.

3. The PDP as claimed in claim 2, wherein the X-electrodes and the Y-electrodes each include a bus electrode made of a conductive material and a transparent electrode.

4. The PDP as claimed in claim 1, wherein the X-floating electrode and the Y-floating electrode of the floating electrode pair is made of a metal conductor.

5. The PDP as claimed in claim 1, wherein the X-floating electrode and the Y-floating electrode of the floating electrode pair is made of a transparent electrode.

6. The PDP as claimed in claim 1, wherein the X-floating electrode and the Y-floating electrode of the floating electrode pair function independently of any electrical signals supplied thereto.

7. The PDP as claimed in claim 1, wherein the X-floating electrode and the Y-floating electrode are disposed to extend along one direction and to be parallel to each other.

8. The PDP as claimed in claim 1, wherein the X-floating electrode is disposed to be electrically insulated for each of the discharge cells.

9. The PDP as claimed in claim 1, wherein the Y-floating electrode is disposed to be electrically insulated for each of the discharge cells.

10. The PDP as claimed in claim 1, wherein each of the X-electrodes and the Y-electrodes is disposed to extend along one direction and to be parallel to each other.

11. The PDP as claimed in claim 1, further comprising a front dielectric layer supported and disposed on the front substrate to cover the electrode pairs.

12. The PDP as claimed in claim 1, further comprising address electrodes supported and arranged on the rear substrate, the address electrodes extending along a direction crossing a direction along which the electrode pairs extend such that overlapping portions of the address electrodes and the electrode pairs respectively form the discharge cells.

13. The PDP as claimed in claim 12, further comprising a rear dielectric layer supported and disposed on the rear substrate to cover the address electrodes.

14. A plasma display panel (PDP), comprising:
a first substrate;
a second substrate, the second substrate overlapping the first substrate;
a plurality of discharge cells between the first substrate and the second substrate;
a plurality of electrode pairs arranged on the first substrate, each electrode pair including an X-electrode and an Y-electrode and each of the discharge cells being associated with at least a portion of one of the X-electrodes and one of the Y-electrodes;
potential increasing means for increasing an electric potential difference between the X-electrode and the Y-electrode of one of the electrode pairs associated with one of the plurality of discharge cells;
phosphor layers respectively disposed within the discharge cells; and
discharge gas existing inside the discharge cells.

15. The PDP as claimed in claim 14, wherein the potential increasing means includes a pair of electrodes arranged between the X-electrode and the Y-electrode of the electrode pair.

16. The PDP as claimed in claim 14, wherein the potential increasing means is made of a conductive material.

17. The PDP as claimed in claim 14, wherein the X-electrode and the Y-electrode of each of the electrode pairs is formed of a conductive material.

18. The PDP as claimed in claim 17, wherein the X-electrode and the Y-electrode of each of the electrode pairs is formed of a non-transparent conductive material.

19. The PDP as claimed in claim 14, wherein the potential increasing means associated with each of the plurality of discharge cells are electrically insulated from each other.

20. The PDP as claimed in claim 14, wherein the potential increasing means associated with each of the discharge cells function independently of any electrical signals supplied thereto.
